(19) United States
(12) Patent Application Publication
(10) Pub. No.: US 2019/0251592 A1
(43) Pub. Date: Aug. 15, 2019

(54) MEDIA PUSHING METHOD AND SYSTEM

(71) Applicant: Tencent Technology (Shenzhen) Company Limited, Shenzhen (CN)

(72) Inventor: Ming YIN, Shenzhen (CN)

(73) Assignee: Tencent Technology (Shenzhen) Company Limited, Shenzhen (CN)

(21) Appl. No.: 16/372,076

(22) Filed: Apr. 1, 2019

Related U.S. Application Data
(63) Continuation of application No. PCT/CN2017/114699, filed on Dec. 6, 2017.

(30) Foreign Application Priority Data
Dec. 6, 2016 (CN) 201611113237.6

(51) Int. Cl. G06Q 30/02; H04L 29/08

(52) U.S. Cl. CPC G06Q 30/0225; H04L 67/26

(57) ABSTRACT

This application discloses a media pushing method and system. The method includes: providing an online service for a user; obtaining a material of target media content; generating the media content according to the material; presenting the media content to the user when duration of the user using the online service reaches a preset time length; and modifying service data corresponding to an account of the user after the media content is presented to the user.

### RELATED APPLICATION

This application claims priority to International PCT Application No. PCT/CN2017/114699, filed with the Chinese Patent Office on Dec. 6, 2017, which claims priority to Chinese Patent Application No. 201611113237.6, filed with the Chinese Patent Office on Dec. 6, 2016, both entitled “MEDIA PUSHING METHOD AND SYSTEM”, which are herein incorporated by reference in their entireties.

### FIELD OF THE TECHNOLOGY

This application relates to Internet technologies, and in particular, to a media pushing presentation method and system.

### BACKGROUND OF THE DISCLOSURE

Currently, some Internet services may provide a virtual or physical reward for a user based on an online time length of the user, thereby increasing adhesion of the user to the service. Usually, a service provider may gather statistics of online duration of using the online service by the user, and the service provider directly provides a reward to the user when the duration reaches a preset time length.

### SUMMARY

Embodiments of this application provide a media pushing method and system, so as to perform media pushing during rewarding a user for an online time length, so that the user can obtain richer media information during rewarding. As such an information promotion capacity of an online time length rewarding service is increased.

The media pushing method in the embodiments may include:

timing duration of a user using an online service this time;

obtaining a material of target media content;

generating the media content according to the material;

presenting the media content when a time monitoring result reaches a preset time length; and

modifying service data corresponding to an account of the user after the media content is presented.

The media pushing system in the embodiments may include:

a timing module, configured to time duration of a user using an online service this time;

a material obtaining module, configured to obtain a material of target media content;

a media generating module, configured to generate the media content according to the material;

a presentation module, configured to present the media content when a time monitoring result reaches a preset time length; and

a data modification module, configured to modify service data corresponding to an account of the user after the media content is presented.

According to the embodiments, when the duration of the user using the online service reaches the preset time length, the target media content is presented to the user, the service data of the user is modified after the media content is presented to provide a reward, so that the user can obtain richer media information during rewarding, and an information promotion capacity of an online time length rewarding service is increased.

### BRIEF DESCRIPTION OF THE DRAWINGS

FIG. 1 is a schematic diagram of a media pushing system according to an embodiment of this application;

FIG. 2 is a flowchart of a media pushing method;

FIG. 3 is another flowchart of a media pushing method;

FIG. 4 is a flowchart of a user authentication method;

FIG. 5a and FIG. 5b are schematic diagrams for the user authentication method of FIG. 4 implementation;

FIG. 6 is another flowchart of a user authentication method;

FIG. 7a and FIG. 7b are schematic diagrams for the user authentication method of FIG. 6 implementation;

FIG. 8 is a flowchart of a user authentication method;

FIG. 9 is a schematic diagram for the user authentication method of FIG. 8;

FIG. 10 is a schematic diagram of a media pushing system; and

FIG. 11 is another schematic diagram of a media pushing system.

### DESCRIPTION OF EMBODIMENTS

For brevity and clarity, the following describes the solutions provided by the present disclosure based on several exemplary embodiments. Details in the embodiments are used merely for helping understand the solutions of the present disclosure, and implementations of the technical solutions of the present disclosure may not be limited to these details. To avoid unnecessarily obscuring the solutions of the present disclosure, some implementations are not described in detail, and only a framework may be given for these implementations. Hereinafter, “including” means “including but not limited to”, “according to . . . ” means “according to at least . . . , but not limited to only . . . ”. This should be explained as that features other than features explicitly recited may also exist.

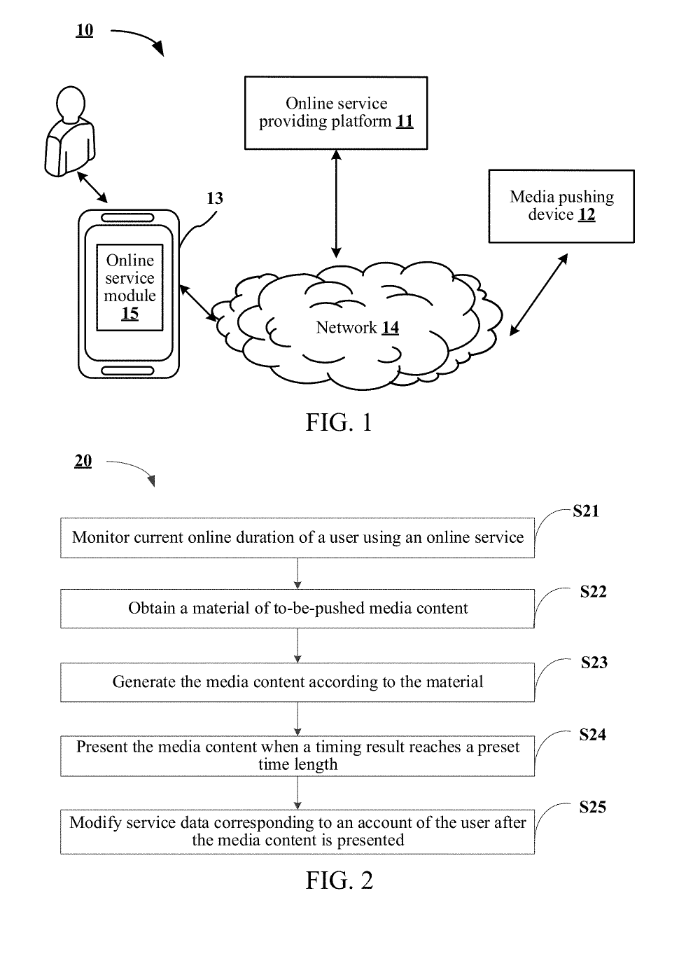

FIG. 1 is a schematic diagram of a media pushing system according to an embodiment of this application. As shown in FIG. 1, the system 10 may include: an online service providing platform 11, a media pushing device 12, a user equipment 13, and a network 14. In the context of this disclosure, the media being pushed can be any of text, images, videos, animation. The media may serve as, e.g., advertisement or entertainment. The term media pushing may be understood as media delivery or content delivery, from, e.g., a server, to a terminal device.

The online service providing platform 11 may comprise one or more servers that provide an online service. The online service providing platform 11 may provide the online service for a user, and provide an online time length reward for the user.

The media pushing device 12 is configured to provide information of to-be-pushed media content as, e.g., reward media content.

The user equipment (also referred to as a terminal device) 13 includes an online service module 15, configured to communicate with the online service providing platform 11 by using the network 14, to implement login of the user, obtain online service data, modify account information of the user, and so on. The user equipment 13 may alternatively communicate with the media pushing device 12 indirectly by using the online service providing platform 11 or directly to obtain the information of the target media content and present the obtained media content to the user.

According to the embodiments, the user equipment 13 or the online service providing platform 11 may provide an online service for a user; obtain a material of target media content; generate the media content according to the material; present the media content to the user when duration of the user using the online service reaches a preset time length; and modify service data corresponding to an account of the user after the media content is presented to the user. The service data for the user account may include but is not limited to access and usage information of the online service by the user recorded by the online service for the user account. The service data may additionally include records of accumulated reward that the user receives for suing the online service.

The method in the embodiments may be implemented by a browser or an application (APP) installed in the user equipment 13 and configured to specially communicate with the online service providing platform 11. For example, the APP may be an online music APP, an online video APP, an online game APP, and the like. The online service may be correspondingly be online music, online video, online game, and the like.

FIG. 2 is a flowchart of a media pushing method 20 according to an embodiment of this application. The method may be implemented by the user equipment 13 in the system 10, or may be implemented by the online service providing platform 11. Alternatively, the method may be implemented by the user equipment 13 performing some steps of the method, and the online service providing platform 11 performing other steps. Herein, even though this service providing method is mainly driven by the user equipment 13 or the online service providing platform 11, it may may also need assistance of another device.

As shown in FIG. 2, the method 20 may include the following steps:

Step S21: Monitor current time duration of a user using an online service.

In some examples, when the user starts to use the online service, a timer may be set, by the user equipment 13, for monitoring the time the duration. In other examples, when the user starts to use the online service, the user equipment 13 may instruct the online service providing platform 11, after the online service providing platform 11 receives the instruction of the user equipment 13, or when data of the online service starts to be provided for the user equipment 13, the timer is set for starting to monitor the online time duration.

Step S22: Obtain a material of target media content.

In some examples, the user equipment 13 may obtain information of the target media content from the media pushing device 12, and obtain the material according to the information. In other examples, the online service providing platform 11 may obtain the information of the target media content from the media pushing device 12, and provide the information for the user equipment 13, and the user equipment 13 obtains the material according to the information. In still some other examples, the online service providing platform 11 may obtain the information of the target media content from the media pushing device 12, obtain the material according to the information, and provide the material for the user equipment 13. Information of media content refers to information for indicating a storage location (for example, a URL) of a material of the media content, or information including material data (for example, when the material is text, the information of the media content may include the text).

The user equipment 13 may obtain the material at any time. In some examples, the user equipment 13 may request the material from the online service providing platform 11 or the media pushing device 12 when a time monitoring result reaches a preset time length. In some examples, before the time monitoring result reaches the preset time length, the user equipment 13 may request the material from the online service providing platform 11 or the media pushing device 12. For example, the user equipment 13 may request to obtain the material when the user logs in to the online service, or the user equipment 13 may request to obtain the material when the time monitoring result reaches a time length value (for example, the preset time length minus a preset value (for example, 3 seconds, 1 second, or 0.3 seconds)). When the material is obtained from the media pushing device 12 and then is provided for the user equipment 13 by the online service providing platform 11, in some examples, the online service providing platform 11 may obtain the material when the user logs into an online server. In some other examples, the online service providing platform 11 may obtain the material when receiving the request, of the user equipment 13, for obtaining the material. In still some other examples, the online service providing platform 11 may obtain the material when a time monitoring result of a local timer reaches a time length (for example, which may be less than the preset time length by a specific value).

Step S23: Generate the media content according to the material.

In some examples, the user equipment 13 may generate the media content according to the material. For example, an APP or a browser that runs in the user equipment 13 may generate the media content according to the material. For example, a webpage providing a service for the user in the browser includes processing logic (for example, Javascript code), and the processing logic in the webpage may pull the material from the online service providing platform 11 and generate the media content.

In other examples, the online service providing platform 11 may generate the media content according to the material. For example, the online service providing platform 11 may generate rendering data of the media content by using a server-side rendering (SSR) technology and according to the material, and provide the rendering data for the user equipment 13 for displaying.

Step S24: Present the media content when a time monitoring result reaches a preset time length.

In some examples, the user equipment 13 or the online service providing platform 11 may set the timer for monitoring the online duration of the user using the online service. For example, the user equipment 13 presents the media content to the user when a time monitoring result of the timer in the user equipment 13 reaches the preset time length. For another example, the online service providing platform 11 may instruct the user equipment 13 to present the media content when a time monitoring result of the timer in the online service providing platform 11 reaches the preset time length.

In other examples, the online service providing platform 11 may record duration of each user using an online service. The user equipment 13 may periodically obtain duration of a user using an online service from the online service providing platform 11, and determine whether the duration reaches the preset time length.

In still some other examples, in response to a message that is received from the user equipment 13 and that instructs that the duration of the user using the online service reaches the preset time length, the online service providing platform 11 may determine the duration of the online use for the user reaches the preset time length.

Step S25: Modify service data corresponding to an account of the user after the media content is presented.

In some examples, the user equipment 13 may instruct the online service providing platform 11 to modify the service data corresponding to the account of the user after presenting the media content.

According to the embodiments, media pushing is performed during rewarding a user for an online time length, so that the user can obtain richer media information during rewarding, and an information promotion capacity of an online time length rewarding service is increased.

The target media content may correspond to a to-be-promoted product, service, or activity, to-be-promoted information, or the like. The material refers to data serving as a carrier of media content. The material may include one or more of the following: text, a picture, an animation, a video, an audio, interactive data, code written by using computer language, and so on. In some examples, the online service providing platform 11 may obtain a user portrayal or user behavior statistics data according to user identification (for example, an account and device identification), and obtain target media content related to the user according to the user portrayal or the user behavior statistics data from the media pushing device 12. In other examples, the media pushing device 12 may obtain the user identification from the online service providing platform 11 or the user equipment 13, and correspondingly obtain the user portrayal or the user behavior statistics data, thereby determining the target media content related to the user, and providing the determined media content for the online service providing platform 11 or the user equipment 13. In this way, a relevance degree between pushed media content and the user can be increased, and interest of the user in the media content is increased, so that media pushing achieves a better effect.

In this specification, the service data corresponding to the account of the user refers to a record of a virtual or physical possession in the account of the user, for example, recording information of a virtual coin, a point, a voucher, a gift in kind, or the like.

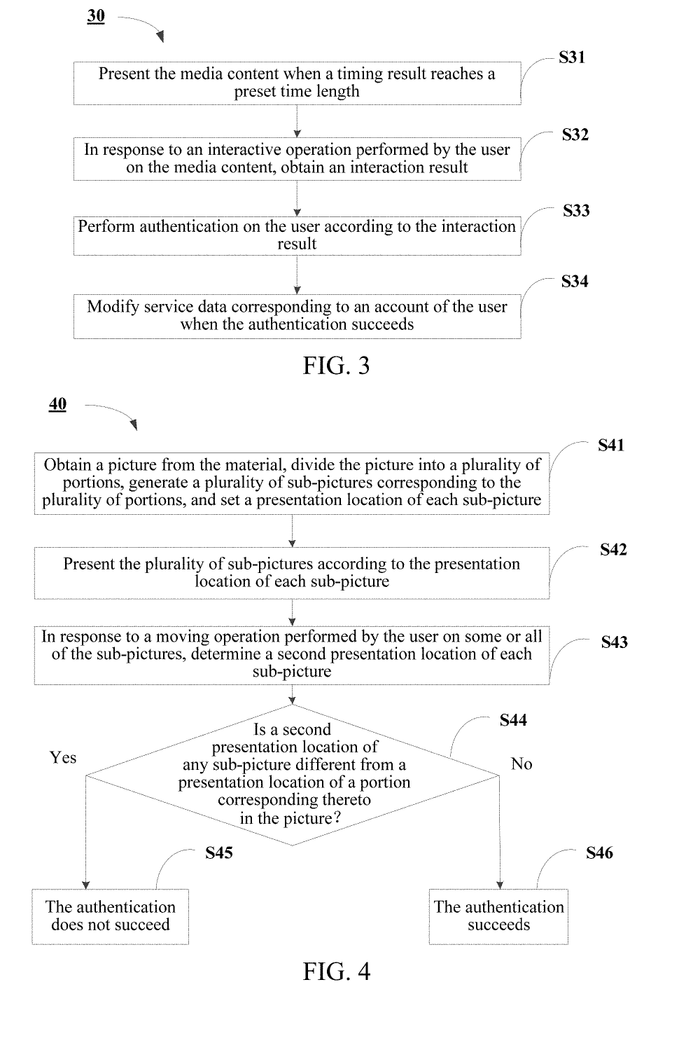

In some examples, the user needs to be authenticated before being rewarded. For example, the user is determined as a real person rather than a machine. In this case, media pushing may be applied to user authentication. FIG. 3 is a flowchart of a media pushing method according to an embodiment of this application. As shown in FIG. 3, the method 30 may include the following steps:

Step S31: Present the media content when a time monitoring result reaches a preset time length.

In some examples, at least one presentation element may be obtained according to the material, a presentation attribute of each presentation element is set, and the at least one presentation element is presented as the media content according to the presentation attribute. The presentation element refers to a file or a set of data that can be independently presented to the user. For example, the presentation element may be a picture, one segment of text, a page control (for example, a textbox or a button), one segment of code, or the like. The presentation attribute refers to a parameter that affects a presentation effect of the presentation element. For example, the presentation attribute may include a size, a presentation location, a typeface, transparency, a flip angle, or the like. The presentation attribute may be set by the user equipment 13, or may be set by the online service providing platform 11 and be provided for the user equipment 13.

Step S32: In response to an interactive operation performed by the user on the media content, obtain an interaction result.

In some examples, prompt information may be presented to the user to prompt the user to perform an operation on a specified presentation element according to a presentation effect of each presentation element or inform the user of a target presentation effect that needs to be achieved and guide the user to perform the interactive operation. The interactive operation may include click, moving, double click, and so on. The interaction result refers to an object affected by the operation of the user. For example, the interaction result may be the presentation element operated by the user, a presentation attribute of the presentation element that is changed by the operation of the user, or the like.

Step S33: Perform authentication on the user according to the interaction result.

The interaction result may be obtained by the user equipment 13 and is used for the user authentication, or may be provided for the online service providing platform 11 by the user equipment 13 and is authenticated by the online service providing platform 11.

Step S34: Modify service data corresponding to an account of the user when the authentication succeeds.

Herein, performing the authentication on the user refers to a process of determining whether an operator is a person or a machine. In the existing technology, a manner of authentication code or an authentication picture is usually used to make the user input an authentication character or click on the authentication picture to perform authentication. Such authentication process represents an extra step. In the embodiments of this application, the material of the target media content is used to generate authentication data, so that the user can further be presented with extra information while the authentication is performed, and a media pushing manner is more interesting, is easier to be accepted by the user, and can leave the user a deeper impression. The authentication process thus would be integrated into the rewarding process rather than being a standout extra step.

The following gives several examples in which the media content is used to perform the authentication on the user. The following examples are only for clarifying the solutions of this application, and do not represent any limitation on other alternative implementations.

FIG. 4 is a flowchart of a user authentication method according to an embodiment of this application. As shown in FIG. 4, the method 40 may include the following steps:

Step S41: Obtain a picture from the material, divide the picture into a plurality of portions, generate a plurality of sub-pictures corresponding to the plurality of portions, and set a presentation location of each sub-picture. A presentation location of at least one sub-picture is different from a presentation location of a portion corresponding thereto in the picture.

In some examples, the picture may be the picture in the material. In some examples, the picture may be generated according to a non-picture material in the material. For example, the one segment of text in the material may be converted into a picture presenting the text. For another example, a dynamic picture or one or more screenshots of the video in the material may serve as the picture. The picture may be divided or segmented in various manners. For example, the picture may be divided into the plurality of sub-pictures in a horizontal direction or a vertical direction. For another example, the picture may be divided in both the horizontal direction and the vertical direction in a preset dividing manner, for example, 2×2 or 3×2, to obtain the plurality of sub-pictures. For another example, the dynamic picture may be divided in units of frames, some or all of the frames are selected as the sub-pictures. Other manners for division may be contemplated, and they are not listed herein.

The set presentation location may be a spatial location, in which each sub-picture is presented, on a display screen of the user equipment. A presentation location of a portion corresponding to a sub-picture in the picture may be a location in space (for example, a spatial location of the portion in the picture before the picture is divided), or may be a location in time (for example, a location of a frame in an animated gif). For example, a neighboring sub-picture of a sub-picture on the display screen may be set to be different from a sub-picture corresponding to a neighboring frame of a frame corresponding to the sub-picture in the animated gif. For another example, a spatial location of a sub-picture in all of the presented sub-pictures may be set to be different from a spatial location of the sub-picture in the original picture (that is, the picture before being divided).

Step S42: Present the plurality of sub-pictures according to the presentation location of each sub-picture (different from the location of the sub pictures in the original picture).

Step S43: In response to a moving operation performed by the user on some or all of the sub-pictures, determine a second presentation location of each sub-picture.

The user may determine a relative location of each sub-picture according to presentation content of each sub-picture, and move some or all of the sub-pictures, so that a spatial arrangement relationship of each sub-picture achieves an arrangement relationship expected by the user.

Step S44: Determine whether a second presentation location of any sub-picture is different from a presentation location of a portion corresponding thereto in the original picture, and perform step S45: Determine that the authentication on the user fails if the second presentation location of any sub-picture is different from the presentation location of the portion corresponding thereto in the original picture; otherwise, perform step S46: Determine that the authentication on the user succeeds.

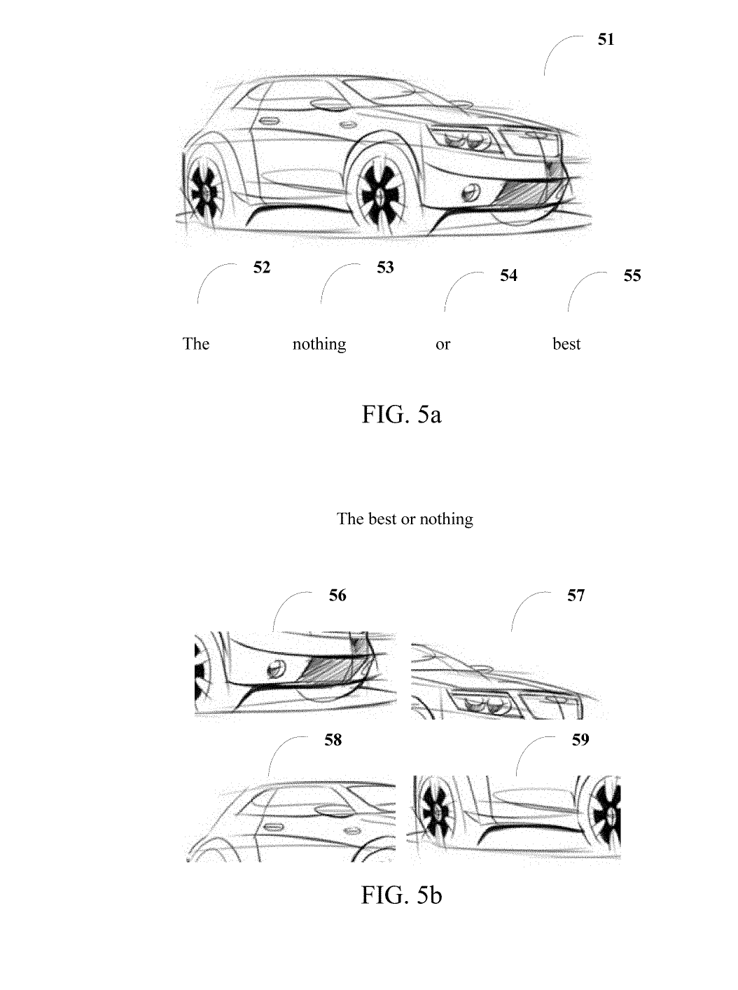

FIG. 5a and FIG. 5b are schematic diagrams of an exemplary user authentication manner according to an embodiment of this application. As shown in FIG. 5a, a picture is generated according to text “The best or nothing” in the material, four sub-pictures 52, 53, 54 and 55 respectively presenting “the”, “best”, “or” and “nothing” are generated after the picture is divided, and an order of the four sub-pictures is scrambled to present the sub-pictures on a screen. In some examples, when the authentication data is presented, another presentation element may further be obtained from the material, and be presented to the user together. For example, a picture 51 in the material may be presented to the user together with the four sub-pictures 52, 53, 54 and 55. As shown in FIG. 5b, a picture is obtained from the material and is divided into four sub-pictures 56, 57, 58 and 59. An order thereof is scrambled to present the sub-pictures, and the text “The best or nothing” in the material may also be presented.

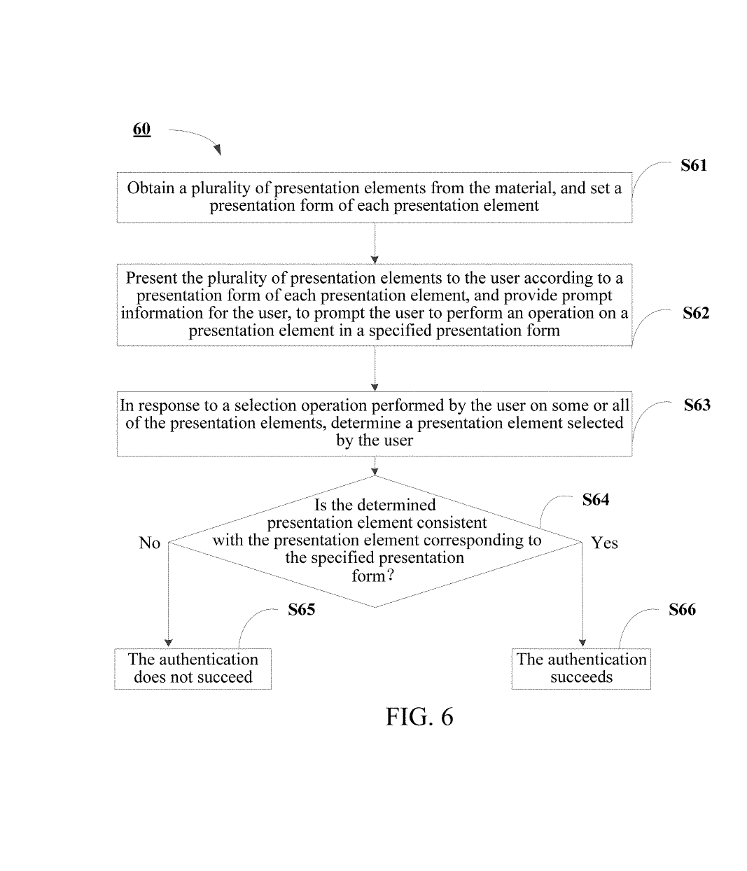

FIG. 6 is a flowchart of a user authentication method according to an embodiment of this application. As shown in FIG. 6, the method 60 may include the following steps:

Step S61: Obtain a plurality of presentation elements from the material, and set a presentation form of each presentation element. There are at least two presentation forms that are set for the plurality of presentation elements.

The presentation form refers to a parameter related to a presentation effect of a presentation element. For example, the presentation form may include the presentation attribute (for example, a size, a location, a typeface, a flip direction, or the like), and may further include a visual effect (for example, blinking, highlighting, framing, or having an animation effect).

Step S62: Present the plurality of presentation elements to the user according to a presentation form of each presentation element, and provide prompt information for the user, to prompt the user to perform an operation on a presentation element in a specified presentation form.

Step S63: In response to a selection operation performed by the user on some or all of the presentation elements, determine a presentation element selected by the user.

Step S64: Compare the determined presentation element with the presentation element corresponding to the specified presentation form, and perform step S65: Determine that the authentication on the user fails if the determined presentation element is inconsistent with the presentation element corresponding to the specified presentation form; and perform step S66: Determine that the authentication on the user succeeds if the determined presentation element is consistent with the presentation element corresponding to the specified presentation form.

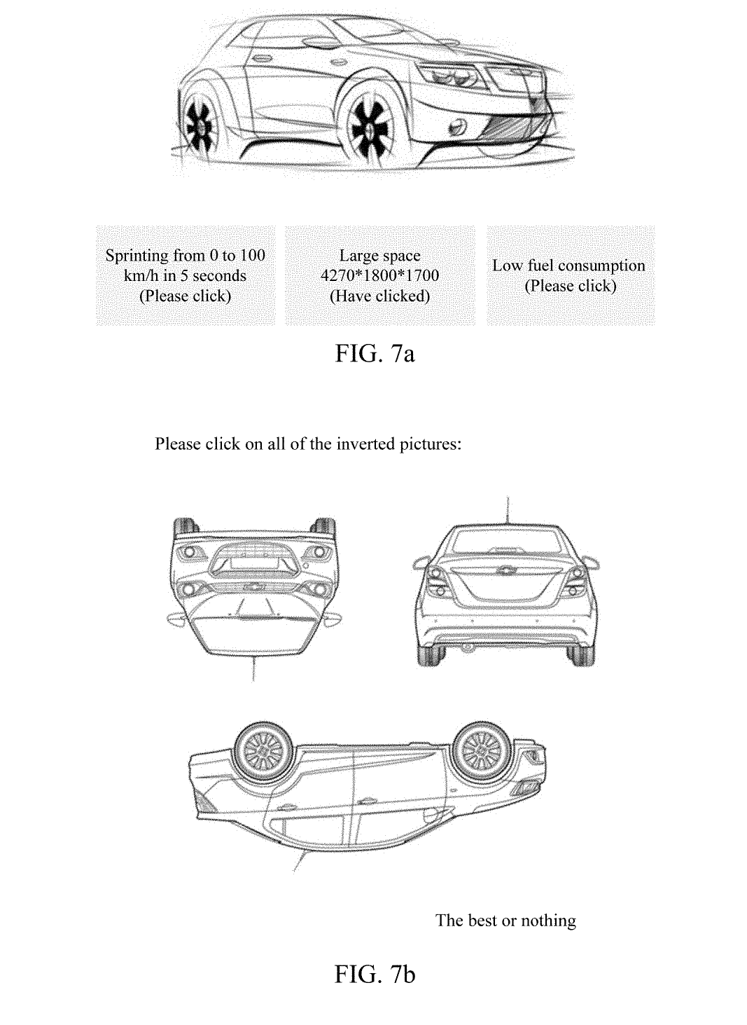

FIG. 7a and FIG. 7b are schematic diagrams of a user authentication manner according to an embodiment of this application. As shown in FIG. 7a, some or all of the text “Sprinting from 0 to 100 km/h in 5 seconds”, “Low fuel consumption”, and “Large space” obtained from a material are highlighted to be presented. In addition, prompt information “Please click” may be presented below the highlighted text, and prompt information “Have clicked” may be presented after the user clicks on the highlighted text. In some examples, a picture in the material may further be presented. As shown in FIG. 7b, a plurality of pictures are obtained from the material, some or all of the pictures are inversely presented, and prompt information “Please click on all of the inverted pictures” is presented.

For example, the user logs into a live website, and browses an automobile evaluating type of a live broadcast online, and cumulative time is one hour. Then, an online time length reward shows on a page of the website, and advertisement content pops up after the user clicks on the reward. The presented advertisement content includes an advertisement picture of an automobile B, three portions of highlighted advertisement text are in the picture: Sprinting from 0 to 100 km/h in 5 seconds, Low fuel consumption, and Large space of 4270*1800*1700. In addition, a text prompt is also presented to prompt the user that the three portions of highlighted advertisement text need to be clicked on to receive the reward. Then, the user clicks on the three portions of advertisement text by using a mouse and obtains the online time length reward.

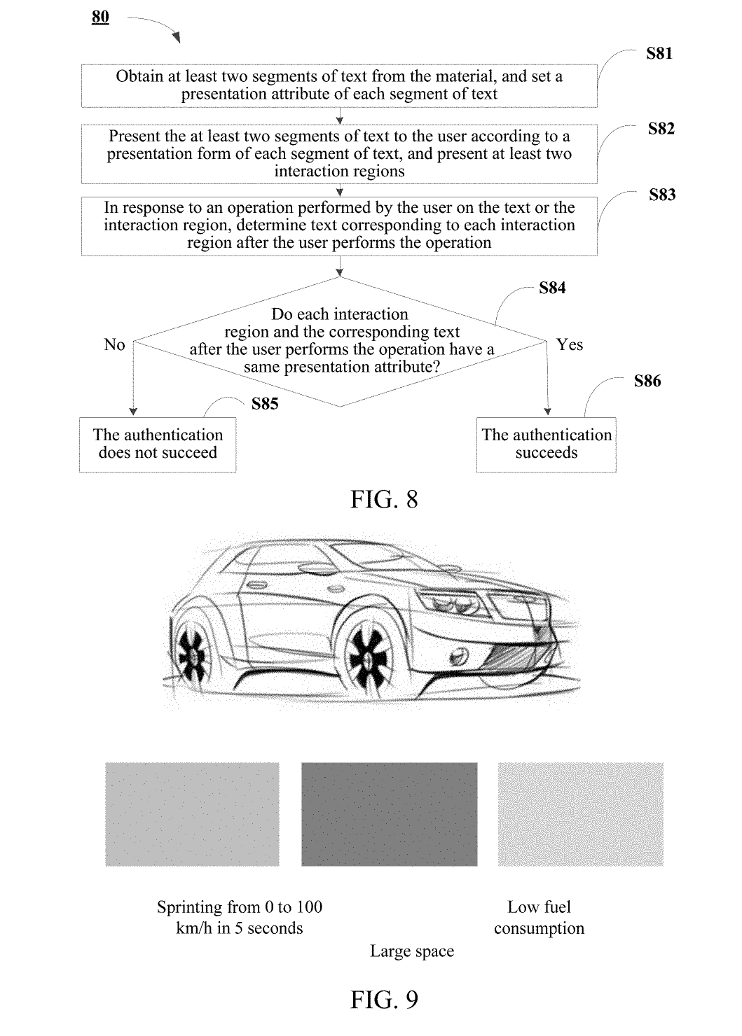

FIG. 8 is a flowchart of a user authentication method according to an embodiment of this application. As shown in FIG. 8, the method 80 may include the following steps:

Step S81: Obtain at least two segments of text from the material, and set a presentation attribute of each segment of text.

Step S82: Present the at least two segments of text to the user according to a presentation form of each segment of text, and present at least two interaction regions. Each interaction region corresponds to one segment of text in the at least two segments of text, and a presentation attribute of each interaction region is set to be the same as a presentation attribute set for the corresponding text, and prompt information is provided for the user, to prompt the user to perform a matching operation on the at least two segments of text and the at least two interaction regions.

Step S83: In response to an operation performed by the user on the text or the interaction region, determine text corresponding to each interaction region after the user performs the operation.

Step S84: Determine whether each interaction region and the corresponding text after the user performs the operation have a same presentation attribute, perform step S85: Determine that the authentication on the user fails if each interaction region and the corresponding text after the user performs the operation do not have the same presentation attribute; and perform step S86: Determine that the authentication on the user succeeds if each interaction region and the corresponding text after the user performs the operation have the same presentation attribute.

FIG. 9 is a schematic diagram of a user authentication manner according to an embodiment of this application. As shown in FIG. 9, text “Sprinting from 0 to 100 km/h in 5 seconds”, “Low fuel consumption”, and “Large space of 4270*1800*1700” is obtained from a material, and different colors are set for the text and presented as text regions 91, 92 and 93 presenting the text. In addition, three interaction regions 94, 95 and 96 are presented and the three interaction regions are respectively presented as regions that are filled with the text colors and that have a shape (for example, a square box, an elliptical shape, or an irregular shape). In response to the moving operation performed by the user, a moving effect of the text regions and the interaction regions is presented. If a text region and an interaction region that have a same presentation location correspond to a same color after being moved, the authentication on the user is determined to succeed.

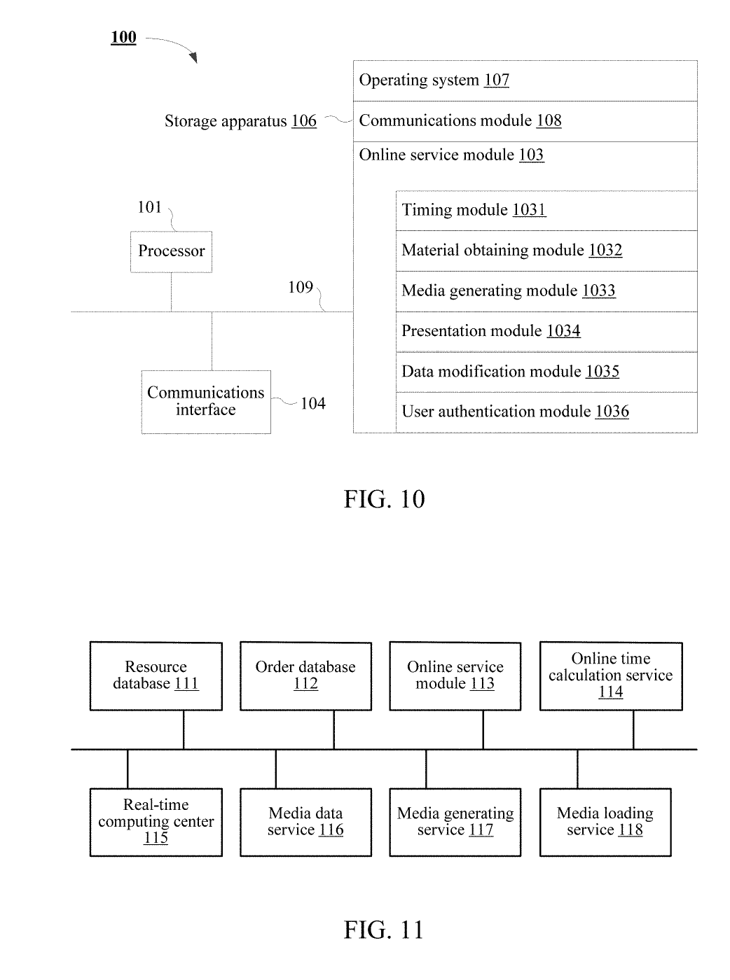

FIG. 10 is a schematic diagram of a media pushing system according to an embodiment of this application. The system 100 may include a processor 101, a communications interface 104, a storage apparatus 106, and an interconnect mechanism 109. The storage apparatus 106 includes an operating system 107, a communications module 108, and an online service module 103.

There may be one or more processors 101 or storage apparatuses 106 respectively. The one or more processors 101 or storage apparatuses 106 may exist in a same physical device, or may be distributed in a plurality of physical devices.

The system 100 may communicate with another device by using the communications interface 104 and a network.

The interconnect mechanism 109 provides a communications channel between components of the system, and the communications channel may include a data bus, a wired connection, a wireless connection, and the like according to a specific usage scenario.

The online service module 103 may perform the media pushing method in the embodiments. As shown in FIG. 10, the online service module 103 in an example may include a timing module 1031, a material obtaining module 1032, a media generating module 1033, a presentation module 1034, and a data modification module 1035.

The timing module 1031 may time duration of a user using an online service this time.

The material obtaining module 1032 may obtain a material of target media content.

The media generating module 1033 may generate the media content according to the material.

The presentation module 1034 may present the media content when a time monitoring result reaches a preset time length.

The data modification module 1035 may modify service data corresponding to an account of the user after the media content is presented.

In some examples, the system 100 may further include a user authentication module 1036. The user authentication module may obtain an interaction result in response to an interactive operation performed by the user on the media content; perform authentication on the user according to the interaction result; and enable the data modification module to modify service data corresponding to an account of the user when the authentication succeeds.

In some examples, the media generating module 1033 may obtain at least one presentation element according to the material, and set a presentation attribute of each presentation element. The presentation module 1034 may present the at least one presentation element according to the presentation attribute.

In some examples, the obtaining media generating module 1033 may obtain a picture from the material, divide the picture into a plurality of portions, generate a plurality of sub-pictures corresponding to the plurality of portions, and set a presentation location of each sub-picture, where a presentation location of at least one sub-picture is different from a presentation location of a portion corresponding thereto in the picture. The presentation module 1034 may present the plurality of sub-pictures according to the presentation location of each sub-picture. The user authentication module may determine a second presentation location of each sub-picture in response to a moving operation performed by the user on some or all of the sub-pictures; and determine whether a second presentation location of any sub-picture is different from a presentation location of a portion corresponding thereto in the picture, and determine that the authentication on the user fails if the second presentation location of any sub-picture is different from the presentation location of the portion corresponding thereto in the picture; otherwise, determine that the authentication on the user succeeds.

In some examples, the media generating module 1033 may obtain a plurality of presentation elements from the material, and set a presentation form of each presentation element, where there are at least two presentation forms that are set for the plurality of presentation elements. The presentation module 1034 may present the plurality of presentation elements to the user according to a presentation form of each presentation element, and provide prompt information for the user, to prompt the user to perform an operation on a presentation element in a specified presentation form. The user authentication module may determine a presentation element selected by the user in response to a selection operation performed by the user on some or all of the presentation elements, compare the determined presentation element with the presentation element corresponding to the specified presentation form, and determine that the authentication on the user succeeds if the determined presentation element is consistent with the presentation element corresponding to the specified presentation form.

In some examples, the media generating module 1033 may obtain at least two segments of text from the material, and set a presentation attribute of each segment of text. The presentation module 1034 may present the at least two segments of text to the user according to a presentation form of each segment of text, and present at least two interaction regions, where each interaction region corresponds to one segment of text in the at least two segments of text, and a presentation attribute of each interaction region is set to be the same as a presentation attribute set for the corresponding text; and provide prompt information for the user, to prompt the user to perform a matching operation on the at least two segments of text and the at least two interaction regions. The user authentication module may determine, in response to an operation performed by the user on the text or the interaction region, text corresponding to each interaction region after the user performs the operation; and determine whether each interaction region and the corresponding text after the user performs the operation have a same presentation attribute, and determine that the authentication on the user succeeds if each interaction region and the corresponding text after the user performs the operation have the same presentation attribute.

FIG. 11 is a schematic diagram of a media pushing system according to an embodiment of this application. The system 110 may include a resource database 111, an order database 112, an online service module 113, an online time calculation service 114, a real-time computing center 115, a media data service 116, a media generating service 117, and a media loading service 118. The system 110 may be implemented by a plurality of physical devices. The plurality of physical devices may communicate with each other by using one or more networks.

The resource database 111 may store resource reservation information. Herein, a resource refers to a resource such as presentation time or a presentation location of media content.

The order database 112 may store an order of target media content.

When a user logs in to an online service by using the online service module 113, the online time calculation service 114 may periodically evoke the real-time computing center 115. The real-time computing center 115 may compute a keyword of a user tag after obtaining a user portrayal and/or user behavior statistics information, and provide the keyword (which may be in a form of structured data, for example, XML) of the user tag for the media data service 116. The media data service 116 queries the order database 112 after obtaining the keyword of the user tag, triggers the media generating service 117 to generate information of the target media content, and enables the media loading service 118 to load a material of the target media content. The media loading service 118 loads the material, generates to-be-presented media content, and presents the media content to the user when duration of the user using the online service reaches a threshold. The media loading service 118 enables the online service module 113 to modify service data corresponding to an account of the user.

It should be noted that, in the foregoing flowcharts and structural diagrams, not all steps and modules are necessary, and some steps or modules may be ignored according to actual needs. A performing sequence of steps is not fixed, and may be adjusted according to needs. Division of modules is only for the convenience of division of functions used in the description. During actual implementation, one module may be implemented by using a plurality of modules, and functions of the plurality of modules may be implemented by using one module. These modules may be located in a same device, or may be located in different devices. In addition, “first” and “second” used in the foregoing descriptions are only for the convenience of differentiating two objects that have a same concept, and do not represent an essential difference.

In each example, each module may be implemented by special hardware or hardware executing machine readable instruction. For example, the hardware may be a specially designed persistent circuit or logical device (for example, a dedicated processor, such as FPGA or an ASIC), configured to complete specific operations. The hardware may further include a programmable logical device or circuit (for example, including a general processor or another programmable processor) that is temporarily configured by software and is configured to perform specific operations.

The machine readable instruction corresponding to each module may be stored in a non-volatile computer readable storage medium, to enable an operating system and the like operated on a computer to complete some or all of the operations described herein. The non-volatile computer readable storage medium includes a floppy disk, a hard disk, a magnetic disk, an optical disc (such as a CD-RON, CD-R, CD-RW, DVD-ROM, DVD-RAM, DVD-RW, and DVD+RW), a magnetic tape, a non-volatile storage card, and a ROM. Selectively, program code may be downloaded from a server computer through a communications network.

In conclusion, the scope of the claims shall not be limited to the implementation of the examples described above. Instead, the specification shall be used in its an entirety, and the broadest interpretation shall be given thereto.

What is claimed is:

1. A media pushing method, applied to a terminal device or a server having a processor, comprising:
providing an online service for a user, the online service providing rewards to the user for continuously using the online service for longer than a preset time length;
determining a source material of media content from a media push server;
generating the media content according to the source material;
presenting the media content to the user as authentication for a reward when a continuous online duration of the user using the online service reaches the preset time length; and
modifying service data corresponding to an account of the user reflecting the reward after the media content is presented to the user and after successful authentication using the media content.

2. The method according to claim 1, before modifying the service data, further comprising:
in response to an interactive operation performed by the user on the media content presented as authentication for the reward, obtaining an interaction result; and
performing the authentication for the reward on the user according to the interaction result.

3. The method according to claim 2, wherein the generating the media content according to the source material comprises: obtaining at least one presentation element according to the source material, and setting a presentation attribute of each presentation element; and
wherein presenting the media content comprises presenting the at least one presentation element according to the presentation attribute.

4. The method according to claim 3:
wherein obtaining at least one presentation element according to the source material, and setting a presentation attribute of each presentation element comprises: obtaining a picture from the source material, dividing the picture into a plurality of portions, generating a plurality of sub-pictures corresponding to the plurality of portions, and setting a presentation location of each sub-picture, wherein a presentation location of at least one sub-picture is different from a presentation location corresponding to the sub-picture in the picture;
wherein presenting the at least one presentation element comprises: presenting the plurality of sub-pictures according to the presentation location of each sub-picture;
wherein obtaining an interaction result comprises: in response to a moving operation performed by the user on some or all of the sub-pictures, determining a second presentation location of each sub-picture; and
wherein performing authentication on the user according to the interaction result comprises: determining whether the second presentation location of any sub-picture is different from the presentation location corresponding to the sub-picture in the picture, and determining that the authentication for the reward on the user fails if the second presentation location of any sub-picture is different from the presentation location corresponding to the sub-picture in the picture; otherwise, determining that the authentication of the reward on the user succeeds.

5. The method according to claim 3:
wherein obtaining at least one presentation element according to the source material, and setting a presentation attribute of each presentation element comprises: obtaining a plurality of presentation elements from the source material, and setting a presentation form of each presentation element, wherein there are at least two presentation forms that are set for the plurality of presentation elements;
wherein presenting the at least one presentation element comprises: presenting the plurality of presentation elements to the user according to a presentation form of each presentation element; and providing prompt information for the user, to prompt the user to perform an operation on presentation elements in a specified presentation form among the at least two presentation forms;
wherein obtaining the interaction result comprises: in response to a selection operation performed by the user on some or all of the presentation elements, determining a presentation element selected by the user; and
wherein performing authentication for the reward on the user according to the interaction result comprises: comparing the determined presentation element with the presentation element corresponding to the specified presentation form, and determining that the authentication for the reward on the user fails if the determined presentation element is inconsistent with the presentation element corresponding to the specified presentation form; and determining that the authentication of the reward on the user succeeds if the determined presentation element is consistent with the presentation element corresponding to the specified presentation form.

6. The method according to claim 3:
wherein obtaining at least one presentation element according to the source material, and setting a presentation attribute of each presentation element comprises: obtaining at least two segments of text from the source material, and setting a presentation attribute of each segment of text;
wherein presenting the at least one presentation element comprises: presenting the at least two segments of text to the user according to a presentation form of each segment of text, presenting at least two interaction regions, wherein each interaction region corresponds to one segment of text in the at least two segments of text, and a presentation attribute of each interaction region is set to be the same as a presentation attribute set for the corresponding text, and providing prompt information for the user, to prompt the user to perform a matching operation on the at least two segments of text and the at least two interaction regions;
wherein obtaining an interaction result comprises: in response to an operation performed by the user on the text or the interaction region, determining text corresponding to each interaction region after the user performs the operation; and
wherein performing authentication on the user according to the interaction result comprises: determining whether each interaction region and the corresponding text after the user performs the operation have a same presentation attribute, and determining that the authentication for the reward on the user fails if each interaction region and the corresponding text after the user performs the operation do not have the same presentation attribute; and determining that the authentication for the reward on the user succeeds if each interaction region and the corresponding text after the user performs the operation have the same presentation attribute.

7. The method according to claim 1, wherein obtaining the source material of the media content, generating the media content according to the source material, and presenting the media content to the user comprises:
obtaining, by the terminal device, the source material from the server, generating the media content by using the source material, and displaying the media content in a display device of the terminal device.

8. The method according to claim 1, wherein obtaining the source material of the media content, generating the media content according to the material, and presenting the media content to the user comprises:
obtaining, by the server, the source material, generating rendering data of the media content by using the source material, and providing the rendering data for the terminal device for display.

9. The method according to claim 1, further comprising:
setting a timer for monitoring the online duration of the user using the online service; and
determining that the online duration of the user using the online service reaches the preset time length when the online duration monitored by the timer reaches the preset time length.

10. The method according to claim 1, further comprising:
periodically obtaining, by the terminal device, the online duration of the user using the online service from the server; and
determining whether the online duration reaches the preset time length.

11. The method according to claim 1, further comprising:
in response to a message that is received from the terminal device indicating that the online duration of the user using the online service reaches the preset time length, determining, by the server, that the duration reaches the preset time length.

12. A media pushing device, comprising: a processor and a memory, the memory storing computer-readable instructions, wherein the processor, when executing the instructions, is configured to:
provide an online service for a user the online service providing rewards to the user for continuously using the online service for longer than a preset time length;
determine a source material of media content from a media push server;
generate the media content according to the source material;
present the media content to the user as authentication for a reward when a continuous online duration of the user using the online service reaches the preset time length; and
modify service data corresponding to an account of the user reflecting the reward after the media content is presented to the user.

13. The device according to claim 12, wherein the processor, when executing the instructions, is further configured to:
in response to an interactive operation performed by the user on the media content presented as authentication for the reward, obtain an interaction result; and perform authentication for the reward on the user according to the interaction result.

14. The device according to claim 13, wherein the processor, when executing the instructions, is further configured to:
obtain at least one presentation element according to the source material, and setting a presentation attribute of each presentation element; and
present the at least one presentation element according to the presentation attribute.

15. The device according to claim 14, wherein processor, when executing the instructions, is further configured to:
obtain a picture from the source material, divide the picture into a plurality of portions, generate a plurality of sub-pictures corresponding to the plurality of portions, and set a presentation location of each sub-picture, wherein a presentation location of at least one sub-picture is different from a presentation location corresponding to the sub-picture in the picture;
present the plurality of sub-pictures according to the presentation location of each sub-picture; and
in response to a moving operation performed by the user on some or all of the sub-pictures, determine a second presentation location of each sub-picture; and determine whether a second presentation location of any sub-picture is different from a presentation location corresponding to the sub-picture in the picture, and determine that the authentication for the reward on the user fails if the second presentation location of any sub-picture is different from the presentation location corresponding to the sub-picture in the picture; otherwise, determining that the authentication for the reward on the user succeeds.

16. The device according to claim 14, wherein the processor, when executing the instructions, is further configured to:
obtain a plurality of presentation elements from the source material, and setting a presentation form of each presentation element, wherein there are at least two presentation forms that are set for the plurality of presentation elements;
present the plurality of presentation elements to the user according to a presentation form of each presentation element, and provide prompt information for the user, to prompt the user to perform an operation on a presentation element in a specified presentation form among the at least two presentation forms; and
in response to a selection operation performed by the user on some or all of the presentation elements, determine a presentation element selected by the user, compare the determined presentation element with the presentation element corresponding to the specified presentation form, and determine that the authentication on the user fails if the determined presentation element is inconsistent with the presentation element corresponding to the specified presentation form; and determine that the authentication on the user succeeds if the determined presentation element is consistent with the presentation element corresponding to the specified presentation form.

17. The device according to claim 14, wherein the processor, when executing the instructions, is further configured to:
obtain at least two segments of text from the source material, and setting a presentation attribute of each segment of text;
present the at least two segments of text to the user according to a presentation form of each segment of text, and present at least two interaction regions, wherein each interaction region corresponds to one segment of text in the at least two segments of text, and a presentation attribute of each interaction region is set to be the same as a presentation attribute set for the corresponding text; and provide prompt information for the user, to prompt the user to perform a matching operation on the at least two segments of text and the at least two interaction regions; and
in response to an operation performed by the user on the text or the interaction region, determine text corresponding to each interaction region after the user performs the operation; and determine whether each interaction region and the corresponding text after the user performs the operation have a same presentation attribute, and determine that the authentication on the user fails if each interaction region and the corresponding text after the user performs the operation do not have the same presentation attribute; and determine that the authentication on the user succeeds if each interaction region and the corresponding text after the user performs the operation have the same presentation attribute.

18. The device according to claim 12, wherein the processor, when executing the instructions, is further configured to:
set a timer for monitoring the online duration of the user using the online service or periodically obtain the online duration of the user using the online service from the server; and
obtain the source material from the server, generating the media content by using the source material, and displaying the media content in a display device of the device.

19. The device according to claim 12, wherein the processor, when executing the instructions, is further configured to:
set a timer for monitoring the online duration of the user using the online service or determining, according to a message received by the device, that the online duration of the user using the online service reaches the preset time length; and
obtain the source material, generate rendering data of the media content by using the material, and provide the rendering data for the device for display.

20. A computer-readable storage medium, storing a computer-executable instruction, the instruction being capable of enabling a processor to perform the following steps:
providing an online service for a user, the online service providing rewards to the user for continuously using the online service for longer than a preset time length;
determining a source material of media content from a media push server;
generating the media content according to the source material;
presenting the media content to the user as authentication for a reward when a continuous online duration of the user using the online service reaches the preset time length; and
modifying service data corresponding to an account of the user reflecting the reward after the media content is presented to the user and after successful authentication using the media content.
